(19) United States
(12) Patent Application Publication
(10) Pub. No.: US 2015/0095173 A1
(43) Pub. Date: Apr. 2, 2015

(54) SYSTEM TO FACILITATE INTEGRATION OF SOFTWARE

(71) Applicant: Hoichau Wong, Shatin, N.T. (CN)

(72) Inventor: Hoichau Wong, Shatin, N.T. (CN)

(73) Assignee: SINOGAEL TECHNOLOGIES LIMITED, Shatin, N.T. (HK)

(21) Appl. No.: 14/381,426

(22) PCT Filed: Feb. 28, 2012
(86) PCT No.: PCT/CN2012/071700

§ 371 Date: Aug. 27, 2014

(51) Int. Cl. G06Q 20/20; G06Q 10/10

(52) U.S. Cl. CPC G06Q 20/209; G06Q 20/202; G06Q 10/107
USPC 705/21

(57) ABSTRACT

A system to facilitate integration of software includes a core integration portion and first and second modules. The core integration portion includes one or more input interfaces and output interfaces. The input interfaces receive incoming data from the first module and the output interfaces interact with the second module. The core integration portion further includes a parsing unit parsing the incoming data received through the input interfaces into transformed data which is passed to the second module to add new functionalities to the first module and/or integrating the first module with the second module. The first module is connected to the input interfaces through a network via a standard protocol. By the system, integration of software is facilitated without modification of software of an existing system, and neither direct access to internal data of the existing system nor exposure of APIs of the existing system is required.

### TECHNICAL FIELD

The present invention relates to a system to facilitate integration of software, particularly to a system to facilitate integration of software to a POS (point-of-sale) terminal without modification on the codes of the software.

### BACKGROUND ARTS

Electronic receipts are becoming a good replacement for paper receipts printed at a point-of-sale. For example, international publication WO2004/100027 entitled “Point-of-Sale Electronic Receipt Generation” has disclosed a method of providing an electronic receipt to a customer at a point-of-sale. Such electronic receipts not only reduce paper consumption to protect the environment, but also provide numerous benefits and possibilities for merchants, individual consumers, businesses, marketers and other entities. To name a few, by using electronic receipts, the use of thermal receipt paper can be decreased, receipts can be better tracked and organized, checkout time at a POS terminal can be shortened, and retailers can substantially reduce their operational costs.

However, to get all the benefits of electronic receipts, a merchant has to face the problem of upgrading its POS terminals. The merchant may choose to replace legacy POS terminals with electronic POS terminals that support electronic receipts, or to add new functionalities to the POS terminals by upgrading the software code on the POS terminals. However obviously both of the solutions will incur a huge cost when there are a number of the POS terminals to be upgraded. This is the usual case for large retailers such as supermarkets or chain stores to bear such cost.

Various efforts have been made in the industry to add new functionalities to POS terminals. One solution needs retailers to install a plug-in on the POS terminal(s) or back-office workstations to capture receipt's data. The digital receipt plug-ins used in such a solution could follow industry standards including ARTS (The Association for Retail Technology Standards)/NRF XML (POSLog and Digital Receipt standards) and GSI UPC bar codes. In such a solution, the software on the POS terminals has to be modified, or data on the client's side have to be directly accessible to the plug-in added.

Another solution provides a receipt dispenser device sitting in-between a POS system and a receipt printer to intercept and convert a traditional, paper-based sales receipt into a paperless receipt for delivery to customer's smartphone. In such a solution, a POS terminal is locally connected to a hardware device, which is in turn connected to a receipt printer and has limited functionality and limited storage space. Thus, such a solution cannot provide customised applications via application container and marketing services, and does not support parsing of incoming receipts.

Other existing solutions may need POS software to implement an API to send receipts (i.e. POS system is to be modified). For example, proprietary protocols for sending and receiving receipts data may be required to add new functionalities to POS terminals, or integrate the functionalities of POS terminals with other devices or systems such as smart phone.

Thus, there exists a need in the industry for a system that can add new functionalities to a POS terminal and/or integrate the POS terminal with other devices or systems without modification of POS software or direct access to internal data of client's systems.

More generally, adding new functionalities or integrating different software system normally requires modification/change/replace existing software, direct access to internal data of existing systems, or knowing the APIs of existing systems. Therefore, there exists a need for a system to facilitate integration of software without modification of software of an existing system, and neither direct access to internal data of the existing system nor exposure of APIs of the existing system is required.

### SUMMARY OF INVENTION

The object of the invention includes providing a system to facilitate integration of software, which advantageously eliminate modification of existing systems by using common standard application protocols which are already implemented in existing software systems.

In one aspect of the invention, a system to facilitate integration of software is provided, which comprises a core integration portion, at least one first module and at least one second module, the core integration portion comprises one or more input interfaces and one or more output interfaces, the input interfaces receive incoming data from the first module, the output interfaces interact with the second module, characterized in that the core integration portion further comprises a parsing unit parsing the incoming data received through the input interfaces into transformed data which is passed to the second module to add new functionalities to the first module and/or integrating the first module with the second module, the first module is connected to the input interfaces through a network via a standard protocol.

In one embodiment of the invention, the standard protocol is one of the Internet print protocol, the standard windows print commands, SMTP, SSH, FTP, SQL, and LPD, the parsing unit parses the incoming data into transformed data by using an incoming data format descriptor.

Preferably, the first module is a POS terminal.

In a preferred embodiment of the invention, the incoming data is raw print data containing receipt information from the POS terminal, the incoming data format descriptor describes the specification and standard format of the receipt, the parsing unit parses the raw print data into digital receipt in digital format that can be analysed and parsed, the digital receipt containing an identification of the first module, an identification of a customer, and details of transaction made by the customer.

Optionally, the digital receipts generated from the incoming data from the first module are saved by the core integration portion in a data storage means, a unique code is generated for the digital receipt and presented to a customer.

In one embodiment of the invention, the second module is a POS printer, a mobile device, an email client, or a web service, and the unique code is printed on paper or displayed on a screen by the second module.

Preferably, the unique code generated for the digital receipt is associated with the customer by the core integration portion, customized information is sent to the customer by the core integration portion according to information contained in the digital receipts associated with the customer.

In another embodiment of the invention, the core integration portion further comprises an application layer, the digital receipts are further processed in the application layer to add additional functionalities to the first module.

In yet another embodiment of the invention, the core integration portion further comprises one or more servers, and the one or more servers are any one of or any combination of a virtual printer server for receiving raw print data, one or more application servers for processing the raw print data, and one or more database servers for storing the transformed data.

In one embodiment of the invention, the first module and the second module are enterprise systems.

Advantageously, the system of the invention is capable of dynamically adding new features to existing system (e.g., adding digital receipts functionalities to existing POS systems) without modification of client's software system. The system of the invention is also advantageous in isolation of client's data because the internal data of client system is not touched. In addition, integration of legacy systems can be facilitated by the system of the invention. Further, the system of the invention can be utilized to provide customers with coupons and promotions based on their unique purchasing habits.

This summary is provided to introduce concepts relating to system to facilitate integration of software. The system will be further described below in the detailed description. This summary is not intended to limiting the scope of the claimed subject matter.

### BRIEF DESCRIPTION OF DRAWINGS

Non-limiting examples are described with reference to the following figures, in which:

FIG. 1 is an illustrative overview block diagram of a system to facilitate integration of software according to an embodiment of the invention;

FIG. 2 is an exemplary data flow chart of a system to facilitate integration of software according to an embodiment of the invention;

FIG. 3 is a flow chart illustrating an exemplary logic executed in a parser layer in a system to facilitate integration of software according to an embodiment of the invention;

FIG. 4 is a flow chart illustrating an exemplary logic executed in an application layer in a system to facilitate integration of software according to an embodiment of the invention;

FIG. 5 is a system context diagram illustrating the digital receipt management system implementation of the system to facilitate integration of software according to an embodiment of the invention; and

FIG. 6 is a data flow diagram illustrating the data flow between the modules of the system to facilitate integration of software according to an embodiment of the invention.

### DETAILED DESCRIPTION

“Module” used herein can be embodied in software, hardware, firmware or a combination thereof, and such a module includes but not limited to one or more devices, software applications, software systems from small scale to large scale (e.g. enterprise level systems). As non-limiting examples, a module can be a POS terminal, a legacy hardware or software system, proprietary systems whose API is not exposed. The system to facilitate integration of software of the invention can advantageously add new functionalities to the first module without modification of its existing software, firmware or hardware, and neither direct access to internal data of the first module nor exposure of APIs of the first module is required. Such new functionalities include any functionality that is conventionally added by modification of software of the first module, direct access to the internal data of the first module, or calling the API of the first module.

By using the system to facilitate integration of software of the invention, the functionalities of various types of first modules can be extended without costly hardware upgrade or software upgrade. For example, large retailers with thousands of legacy POS terminals can save considerable expenses on upgrading the POS terminals. In another embodiment, enterprise systems (e.g. the enterprise level systems of a manufacturer and its suppliers) can be integrated by the system of the invention without exposing internal data structure or APIs. In yet another embodiment, B2B software communication without human interaction or modification can be implemented by using the system of the invention.

Incoming data in the embodiments of the invention can be any data that is output by the first module via any standard interface supported by the module. For example, incoming data can be in the form of raw print data, email, text, or other binary format. Preferably, the incoming data may be generated by the first module through standard windows print command or Internet print protocol, which is universally supported by various POS terminals, software applications or enterprise systems.

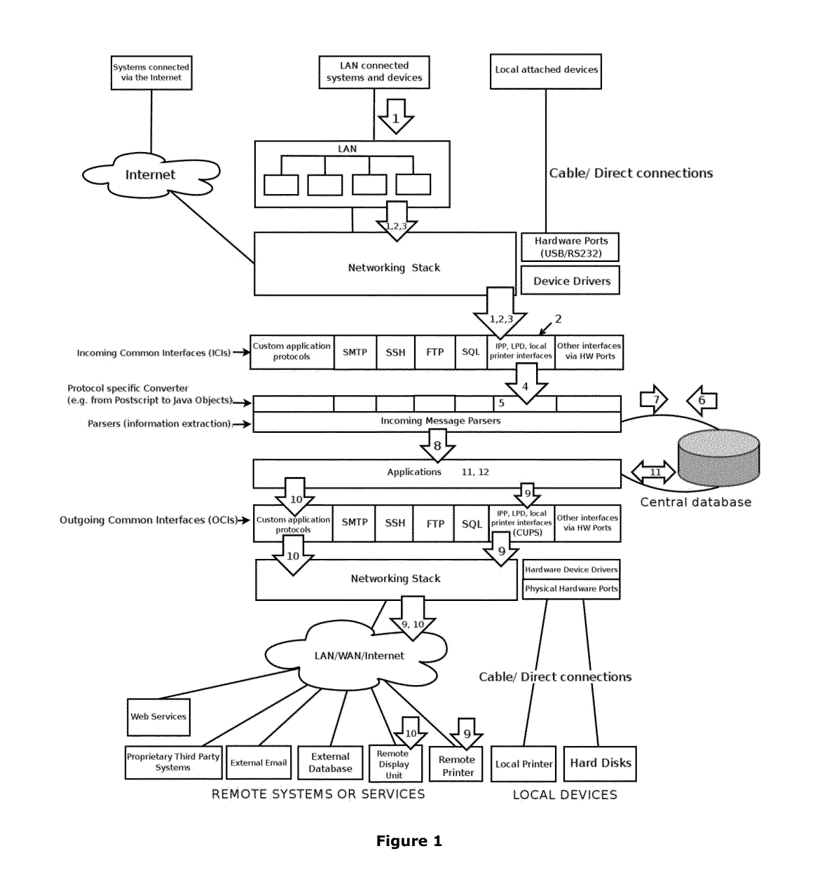

FIG. 1 is an illustrative overview block diagram of a system to facilitate integration of software according to an embodiment of the invention. As shown in FIG. 1, the system of the invention includes one or more input interfaces, i.e. incoming common interfaces (ICIs), and output interface by which external application or system (e.g. POS Terminal) can communicate with the system, e.g. embodied as application servers, via standard protocols (e.g. Internet Print Protocol, standard windows print commands). At least one first module are represented by various systems and/or devices connected to the core integration portion of the invention in different manners. As non-limiting examples, at least one first module can be embodied as systems connected via the Internet, LAN connected systems and devices, and/or local attached devices. As illustrated, at least one first module can be connected to the core integration portion of the invention via WAN, e.g. Internet, or LAN (Local Area Network), or cabled direct connection. As an example, WAN or LAN connection can be on a network layer based on TCP/IP protocols. Direct connection may be via hardware ports such as USB or RS232. Preferably, the at least one first module are connected to the core integration portion through network via a standard protocol. Such configured, a first module can be located in a place remote to the core integration portion without direct or physical connection to the core integration portion of the invention. Optionally, systems or devices connected via the Internet or LAN may connect to the incoming common interfaces through network stack, and local attached devices may connect to the incoming common interfaces through hardware ports and/or device drivers.

The incoming common interfaces as shown in FIG. 1 supports standard protocols including but not limited to SMTP, SSH, FTP or other network protocols, SQL, IPP (Internet Print Protocol), LPD (Line Printer Daemon protocol), local printer interfaces, or other interfaces via hardware ports. In a non-limiting example, the incoming common interfaces can also supports custom application protocols. However, support for custom application protocols is not required for the incoming common interfaces because the number of first modules can be connected to the integration of the system of the invention will be limited by using such custom protocols. Preferably, standard printing protocols can be used to send receipt data to the servers of the system, as standard printing is already supported in all POS software.

In an exemplary embodiment of the invention, parsers in parsing layer of the core integration portion of the invention parse the incoming data into transformed data by using an incoming data format descriptor. “Parser Layer” herein can be embodied as a conversion layer to convert incoming request (e.g. Raw Print data) to a format (e.g. Java Objects or XML files) applications in application layer can be understood or processed. “Application Layer” herein can be embodied as an application container (e.g. Java EE application server container) which allow solutions to be implemented or new functionalities to be provided. In one embodiment, incoming data, e.g. Raw Print data, are firstly processed by a protocol specific converter to be transformed e.g. from Postscript to Java objects) and then be passed to one or more incoming message parsers to extracting information contained in the incoming data. The incoming message parsers may feed the parsed data into the application layer for further processing, or directly store the parsed data in a central database. In the application layer, the parsed data can be utilized by various applications for different purpose. For example, parsed data in the form of digital receipts can be processed in the application layer to add new functionalities to or enhance existing functionalities of the one or more first module. The first module(s) can be embodied in a variety of forms, such as existing POS terminals or enterprise systems, the functionalities of which conventionally can be added or enhanced by modifying their software/firmware/hardware through extra efforts.

The system of FIG. 1 further includes outgoing common interfaces (OCIs), i.e. interfaces which allow applications in application layer to interact with external system or appliances, such as remote systems or services, e.g. Web services, proprietary third party systems, external email systems, external databases, remote display unit, or remote printer; or local devices, e.g. local printer, or hard disks. As non-limiting examples, the outgoing common interfaces can be implemented as SMTP, SSH, FTP, SQL, IPP, LPD, or local printer interfaces (CUPS), or other interfaces via hardware ports. The outgoing common interfaces can support custom application protocols, such that the system of the present invention can be adaptively used in a wide range of software/hardware environments, and send outgoing data/output data in different formats that are acceptable by a variety of second modules. However, standard printing protocols can also be used to send outgoing data to remote or local printers that receive raw print data.

As shown in FIG. 1, the second module can be implemented as various remote systems or services, and/or local devices. In an exemplary embodiment of the invention, the core integration portion interacts with at least one second module.

In an exemplary embodiment, the system of FIG. 1 further includes a central database. However, the database of the system of the present invention can include a plurality of databases or distributed databases. In one embodiment, the database can be used to save e.g. digital receipts generated from the incoming data from the first module, related information for the processing of digital receipts, customer information and etc.

A person skilled in the art will understand that the system of FIG. 1 can be implemented as a POS digital receipt system. However, the implementations of the system are not limited to such POS digital receipt system, but can be embodied in other forms of systems to facilitate integration of software, such as B2B communication automation system, enterprise systems integration system, or system that adds new functionalities to legacy systems without modification of existing software.

The operation of an exemplary POS digital receipt system is illustrated in FIG. 1 through the path connected by arrows. The details of the operation of the system are described as follows. Description of operations taking place at numbered arrows is set forth below, and the following numbering corresponds to the numbering of arrows in FIG. 1.

1) POS System (unmodified), POS Printers and the servers which embody the system of the invention (Virtual printer server, application servers and database servers, etc.) are connected to a network.

2) POS Terminals use the virtual printers as their default receipt printer, e.g. using a generic printer driver (e.g. Postscript).

3) Unmodified POS issue print request (e.g. when a payment is received and receipt needed to be printed), Virtual printer server receiving the raw print data and converting it into a digital format (digital receipt) that can be analysed and be parsed (for example in PDF or textual format).

Operations taking place at arrow 4 can include but not limited to the operations as described in the following items 4a) and/or 4b).

4a) The digital receipt is put into a polled folder (directory or database). A background process is running which check, in a given interval, for the content of the folder and push the receipts inside the folder to the main application server.

### OR

4b) The digital receipt is push to the main application server.

In both cases the identification of the POS terminal is encoded in the receipt files (So the system knows which printer the paper receipt shall be printed if customers demand paper receipt).

5) Application Server receives receipts from printer server and passes them to the Parser Layer.

6) Parser instances are loaded with “Receipt Format Descriptor”, which can be loaded from an XML descriptor, or from a defined database. The descriptor describes the specification and standard format of the receipts (e.g. Line 3 is Date and Time of transaction, Column 5 from Line 10 onward is quantity, etc.).

7) The digital receipt is parsed and the parsed content may be stored in the receipt database.

8) The digital receipt is passed to the Application Layer, where optional applications can be written to support additional functionalities of the system.

9) Paper Receipt Printing: To check if paper receipt is required to be printed, application logic is implemented to detect such requirement. In case where paper receipt is required, a print request is sent to an “Outward Print Service”, where it is used to manage real POS printer connection. As digital receipts are encoded to included POS terminal identification, “Outward Print Service” knows which POS Printer to connect.

Operations taking place at one or more arrows 10 can include but not limited to the operations as described in the following items 10a), 10b), 10c) and/or 10d).10a) QRCode: A unique QRCode (or barcode, or any unique coding mechanism) is generated for every receipt, and is then presented to the customers (by printing QRCode to the POSPrinter (10b) or display on a screen as indicated in (10c). The QRcode is associated to a particular receipt and is saved to the receipt database.

10b) The QRCode is printed via “Outward Print Service” as described in item 9).

### OR

10c) The QRCode is displayed in a display (via the Outgoing Common Interface).

### AND

10d) In both 10b) and 10c) customers who installed an mobile applications (e.g. Android or iPhone) for the digital receipt services, then scanned the QRCode with the application. The receipt is then associated with the customer.
A signal is sent to the main server of the system and the association (receipt and customer) is saved to the database. The digital receipt can be downloaded and displayed anytime afterward (via phone or website).

11) Digital receipt with some unique customer details (i.e. Octopus Card, membership card). For example, for every purchases made with Octopus card or membership card, the card number is printed on the receipts. After the receipt is parsed in Parsing Layer, this information can be used to associate a receipt with a customer. A customer may require to register their cards with the core integration portion of invention, or the services provided by the core integration portion can be integrated to merchants membership card scheme.

12) Marketing applications can optionally be implemented in the application layer.

Although the above described path, i.e. sequence of operations in FIG. 1 illustrates a digital receipts system implementation for existing POS system, a person skilled in the art will understand that other paths (not shown) can be followed to realize other implementations of the system. As non-limiting examples, the system can also be implemented as customized enterprise applications, without requirement to change the existing software code, provided there is a standard way to send data (i.e. printing, email, etc.), as well as B2B communication automation system, even if software used between different parties are not compatible (i.e. data bridging).

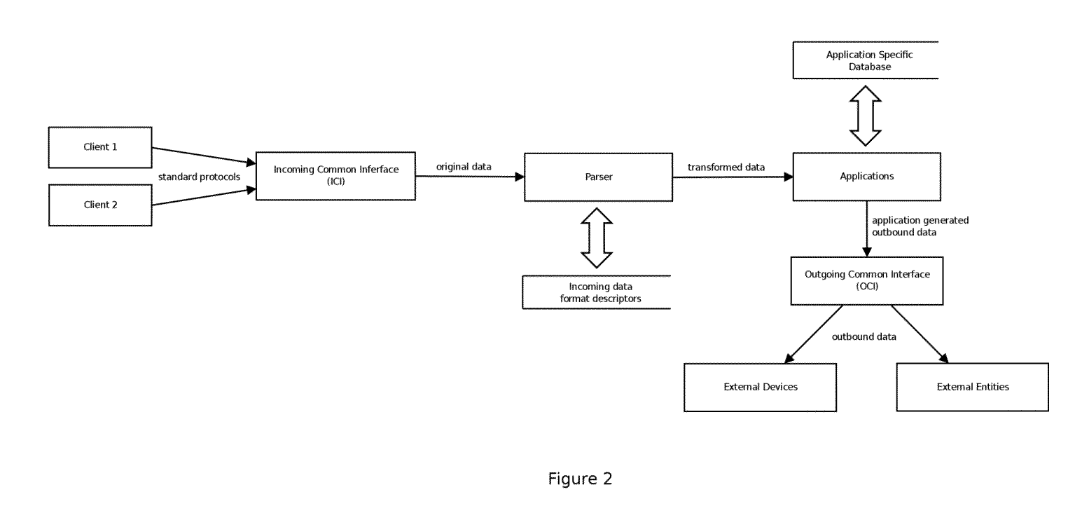

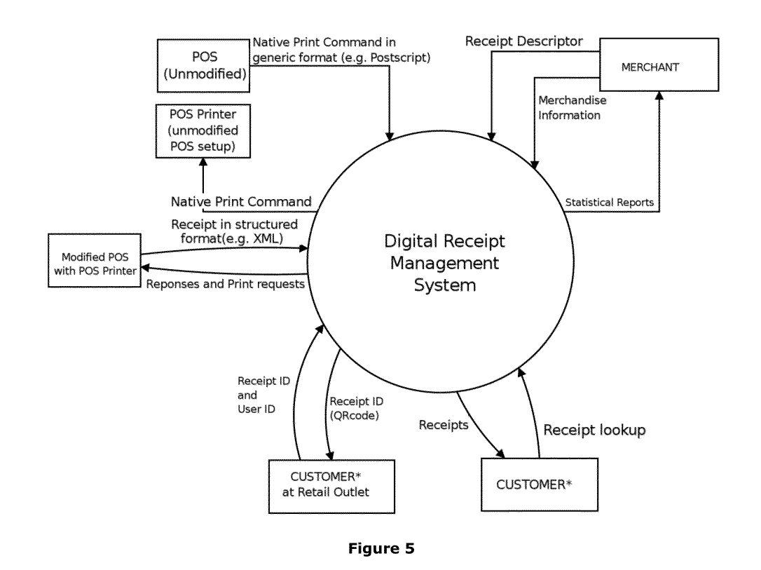

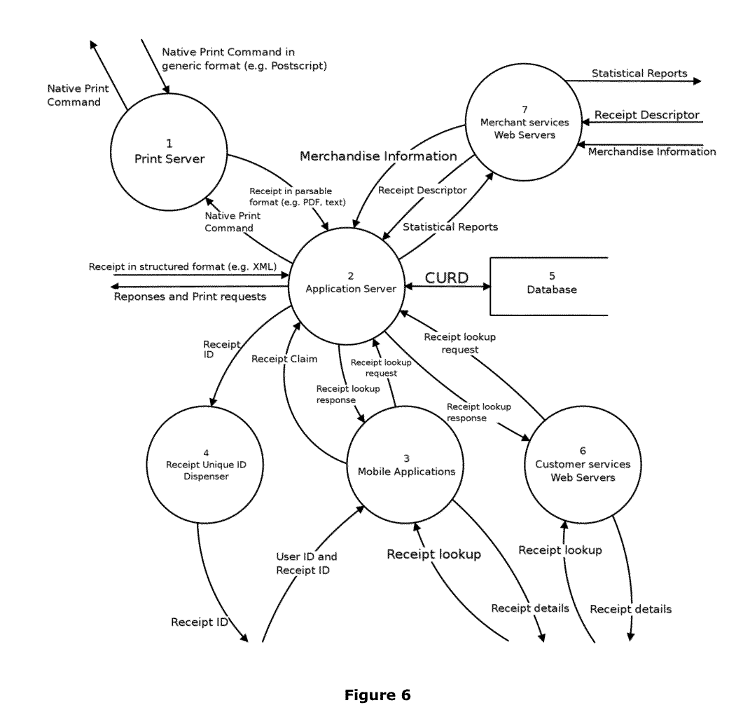

FIG. 2 is an exemplary data flow chart of a system to facilitate integration of software according to an embodiment of the invention. As shown in FIG. 2, incoming data from client 1 and 2 are received through incoming common interface and passed to the parser in the parsing layer. The parser parses the original incoming data into transformed data by using an incoming data format descriptor. Subsequently, the transformed data is passed to application layer for further processing. As an example, the transformed data (i.e. digital receipt) is saved in a database server of the system, and a unique code is generated for the digital receipt and presented to a customer. Optionally, when a paper receipt is requested by the customer who made the transaction, the digital receipt can be sent from the application layer through an outgoing common interface, i.e. an output interface, to a POS printer. Alternatively, the digital receipt can be sent through the outgoing common interface to the mobile device of the customer and displayed on its screen. Digital receipts stored in the system can be for example viewed, searched, and/or organized by the customer who is associated with the digital receipts. In an embodiment of the invention, the digital receipts can be analyzed by the system in the application layer to recognize the pattern in the purchases of the customer so as to display related coupons or ads to the customer on the screen of his/her mobile device, interface of email client and so on. The details of data flow of the system to facilitate integration of software of the invention will be described below in FIGS. 5 and 6.

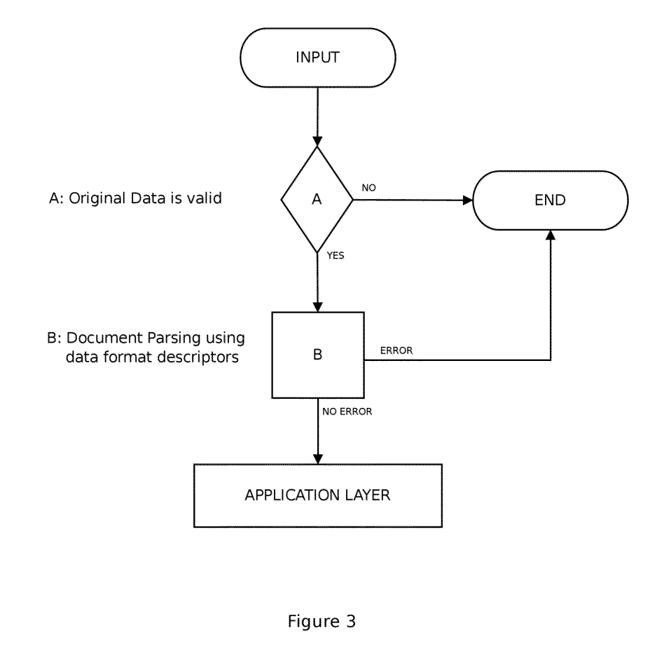

FIG. 3 is a flow chart illustrating an exemplary logic executed in a parser layer in a system to facilitate integration of software according to an embodiment of the invention. In the embodiment as shown in FIG. 3, the validity of original incoming data is firstly checked. If the original incoming data is invalid, the data will not be passed to the application layer and the processing ends. If it is valid, then the data will be parsed with loaded data-format descriptor (i.e. incoming data format descriptor). Only the incoming data is successfully parsed, it will be passed to the application layer.

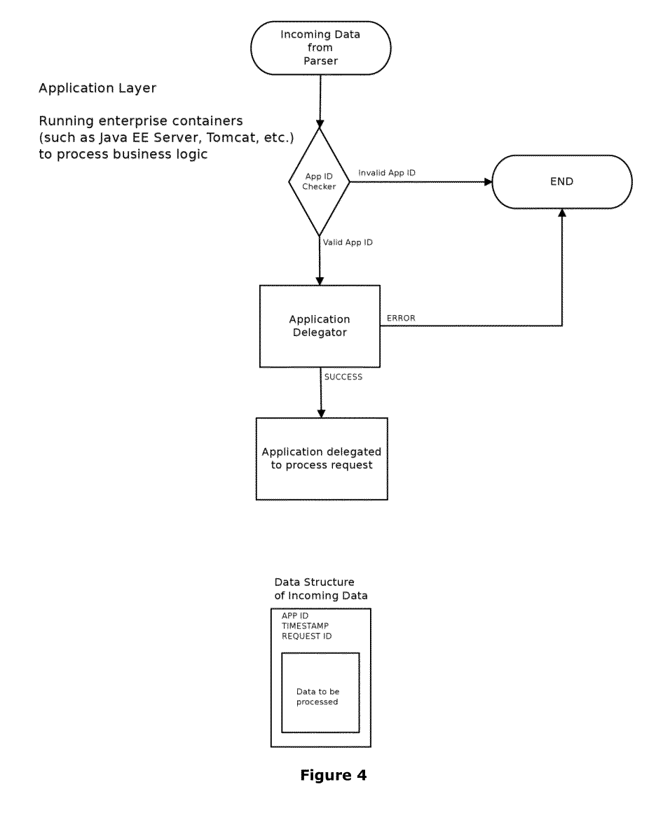

FIG. 4 is a flow chart illustrating an exemplary logic executed in an application layer in a system to facilitate integration of software according to an embodiment of the invention. Since there can be a plurality of applications hosted/residing in the application layer, the system of the present invention may include a mechanism to decide which application will process certain incoming data. The logic executed by one such exemplary mechanism is illustrated in FIG. 4. In one embodiment, the application ID contained in the data from the parser is checked. If the application ID is invalid, the request for processing the incoming data is determined to be invalid and the process ends. If the application ID is valid, then an application delegator will check the request. When the check is successful, the incoming data will be passed to the respective applications to process the request, or if any error is found, the process will end. A person skilled in the art will understand that data transferred from the application layer may include the application data from client and a data wrapper containing the application ID, transaction number, and request ID, such that the transferred data can be properly directed and organized within the system.

FIG. 5 is a system context diagram illustrating the digital receipt management system implementation of the system to facilitate integration of software according to an embodiment of the invention. As non-limiting examples, FIG. 5 illustrates different context/environment in which the system of the invention can be implemented and utilized. The system of the invention is implemented as a digital receipt management system as shown in FIG. 5. However, a person skilled in the art will understand that the embodiments of the system of the invention are not limited to such digital receipt management systems.

In one exemplary scenario, the digital receipt management system receives native print command in generic format (e.g. Postscript) from an unmodified POS terminal, where the software/firmware/hardware of the POS terminal can be unmodified. After raw print data from the unmodified POS terminal is parsed and transformed into a digital receipt and further processed, the digital receipt management system sends native print command to a POS printer with unmodified POS setup such that paper receipt corresponding to the digital receipt can be printed out as requested by a customer. In such a configuration, the digital receipt management system is transparent to both the POS terminal and the POS printer.

In another exemplary scenario, the digital receipt management system receives digital receipt in structured format (e.g. XML) from a modified POS terminal with POS printer and sends response and print requests to the same POS terminal with POS printer.

In one exemplary scenario, as described in operations associated with arrows 10 in FIG. 1, the digital receipt management system sends Receipt ID in QRCode to a customer at retail outlet and receives Receipt ID and User ID from the customer.

In another exemplary scenario, digital receipt management of the invention receives receipt lookup query from a customer and sends digital receipts information to the customer in response.

In yet another exemplary scenario, the digital receipt management system of the invention can interface with one or more merchant systems to add more functionalities. For example, the digital receipt management system can receive receipt descriptor and merchandise information from the merchant systems and send statistical reports to merchant systems in response.

FIG. 6 is a data flow diagram illustrating the data flow between the modules of the system to facilitate integration of software according to an embodiment of the invention. The data flow diagram of FIG. 6 further illustrates the components of the system to facilitate integration of software of the present invention and the interaction between the first module, the second module and the core integration portion of the system.

In one embodiment, the system of the invention may include one or more printer servers to receive native print command in generic format (e.g. Postscript) from the first module such as a POS terminal and send out native print command to a POS printer.

In another embodiment, the system of the invention may include one or more application servers to implement the logic executed in the application layer. As non-limiting examples, the application server may receive receipt in parsable format (e.g. PDF, text) from the print server and returns native print command to the print sever after processing; receive receipt in structured format (e.g. XML) and returns responses and print requests; perform CURD (create, updated, read, and deleted) operations on one or more databases; interfacing and interacting with merchant services web servers; interacting with customer services web servers to receive receipt lookup request from a customer and returns receipt lookup response to the customer correspondingly. In one embodiment, customers may claim receipt ownership by using their mobile phones and capture receipt unique code from receipt unique ID dispenser 4. Receipt related queries may also be initialised from the mobile application. The receipt unique ID dispenser can be a device to dispense receipt unique code and may be for example a screen or a printer. In one embodiment, the customer services web servers and merchant services web servers can be web façade to business logic for customers (i.e. receipt lookup) and merchants (i.e. update receipt descriptor or merchandises).

Although the subject matter of the invention has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A system to facilitate integration of software, comprising a core integration portion, at least one first module and at least one second module, the core integration portion comprises one or more input interfaces and one or more output interfaces, the input interfaces receive incoming data from the first module, the output interfaces interact with the second module, characterized in that the core integration portion further comprises a parsing unit parsing the incoming data received through the input interfaces into transformed data which is passed to the second module to add new functionalities to the first module and/or integrating the first module with the second module, the first module is connected to the input interfaces through a network via a standard protocol.

2. The system of claim 1, wherein the standard protocol is one of the Internet print protocol, the standard windows print commands, SMTP, SSH, FTP, SQL, and LPD, the parsing unit parses the incoming data into transformed data by using an incoming data format descriptor.

3. The system of claim 2, wherein the first module is a POS terminal.

4. The system of claim 3, wherein the incoming data is raw print data containing receipt information from the POS terminal, the incoming data format descriptor describes the specification and standard format of the receipt, the parsing unit parses the raw print data into digital receipt in digital format that can be analysed and parsed, the digital receipt containing an identification of the first module, an identification of a customer, and details of transaction made by the customer.

5. The system of claim 4, wherein the digital receipts generated from the incoming data from the first module are saved by the core integration portion in a data storage means, a unique code is generated for the digital receipt and presented to a customer.

6. The system of claim 5, wherein the second module is a POS printer, a mobile device, an email client, or a web service, and the unique code is printed on paper or displayed on a screen by the second module.

7. The system of claim 6, wherein the unique code generated for the digital receipt is associated with the customer by the core integration portion, customized information is sent to the customer by the core integration portion according to information contained in the digital receipts associated with the customer.

8. The system of claim 7, wherein the core integration portion further comprises an application layer, the digital receipts are further processed in the application layer to add additional functionalities to the first module.

9. The system of any one of the claims 1-8, wherein the core integration portion further comprises one or more servers, and the one or more servers are any one of or any combination of a virtual printer server for receiving raw print data, one or more application servers for processing the raw print data, and one or more database servers for storing the transformed data.

10. The system of any one of the claims 1-2, wherein the first module and the second module are enterprise systems.
